(19) United States
(12) Patent Application Publication
(10) Pub. No.: US 2024/0104776 A1
(43) Pub. Date: Mar. 28, 2024

(54) CAMERA CALIBRATION APPARATUS, CAMERA CALIBRATION METHOD, AND NON-TRANSITORY COMPUTER READABLE MEDIUM STORING CAMERA CALIBRATION PROGRAM

(71) Applicant: NEC Corporation, Minato-ku, Tokyo (JP)

(72) Inventor: Noboru YOSHIDA, Tokyo (JP)

(73) Assignee: NEC Corporation, Minato-ku, Tokyo (JP)

(21) Appl. No.: 17/769,077

(22) PCT Filed: Nov. 11, 2019
(86) PCT No.: PCT/JP2019/044145

§ 371 Date: Apr. 14, 2022

(51) Int. Cl. G06T 7/80; G06T 7/70

(52) U.S. Cl. CPC G06T 7/80; G06T 7/70

(57) ABSTRACT

A camera calibration apparatus (10) according to the present disclosure includes a skeleton detection unit (11) for detecting a two-dimensional skeletal structure of a person based on a two-dimensional image captured by a camera, a vector calculation unit (12) for calculating a skeleton vector indicating a direction and a size of a skeleton of the person in the two-dimensional image based on the two-dimensional skeletal structure detected by the skeleton detection unit (11), and a parameter calculation unit (13) for calculating a camera parameter of the camera based on the skeleton vector calculated by the vector calculation unit (12).

### TECHNICAL FIELD

The present disclosure relates to a camera calibration apparatus, a camera calibration method, and a non-transitory computer readable medium storing a camera calibration program.

### BACKGROUND ART

Recently, a technique in which attributes and behavior, etc of a person are recognized from an image captured by a camera has been used. In such image recognition technology, there is a need for calibration to obtain camera parameters for converting coordinates and sizes of two-dimensional images into three-dimensional spaces of the real world.

As a related technique, for example, Patent Literature 1 to 3 is known. Patent Literature 1 discloses that camera parameters are estimated by obtaining information such as a known height in an image. Patent Literature 2 describes collecting coordinate data of a plurality of pedestrians in an image and calculating camera parameters. Patent document 3 describes estimation of camera parameters of a plurality of cameras from images of the plurality of cameras. In addition, Non Patent Literature 1 is known as a technique related to skeleton estimation of a person.

### CITATION LIST

### Patent Literature

Patent Literature 1: International Patent Publication No. WO 2013/111229 Patent Literature 2: Japanese Unexamined Patent Application Publication No. 2005-233846
Patent Literature 3: Japanese Unexamined Patent Application Publication No. 2019-102877

### Non Patent Literature

Non Patent Literature 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### SUMMARY OF INVENTION

### Technical Problem

Although camera parameters can be obtained by using known information as disclosed in Patent Literature 1, it is necessary to manually input necessary information from outside. On the other hand, the camera parameters can be easily calculated by statistically processing a plurality of pieces of information as in Patent Literature 2. However, in this case, there is a possibility that the accuracy of calculating the camera parameters may become poor. Therefore, there is a problem that it is difficult to obtain camera parameters with high accuracy in a related technique.

In view of such problems, an object of the present disclosure is to provide a camera calibration apparatus, a camera calibration method, and a non-transitory computer readable medium storing a camera calibration program that can easily and accurately obtain camera parameters.

### Solution to Problem

In an example aspect of the present disclosure, a camera calibration apparatus includes: skeleton detection means for detecting a two-dimensional skeletal structure of a person based on a two-dimensional image captured by a camera; vector calculation means for calculating a skeleton vector based on the detected two-dimensional skeletal structure, the skeleton vector indicating a direction and a size of a skeleton of the person in the two-dimensional image; and parameter calculation means for calculating a camera parameter of the camera based on the calculated skeleton vector.

In another example aspect of the present disclosure, a camera calibration method includes: detecting a two-dimensional skeletal structure of a person based on a two-dimensional image captured by a camera; calculating a skeleton vector based on the detected two-dimensional skeletal structure, the skeleton vector indicating a direction and a size of a skeleton of the person in the two-dimensional image; and calculating a camera parameter of the camera based on the calculated skeleton vector.

In another example aspect of the present disclosure, a non-transitory computer readable medium storing a camera calibration program causes a computer to execute processing of: detecting a two-dimensional skeletal structure of a person based on a two-dimensional image captured by a camera; calculating a skeleton vector based on the detected two-dimensional skeletal structure, the skeleton vector indicating a direction and a size of a skeleton of the person in the two-dimensional image; and calculating a camera parameter of the camera based on the calculated skeleton vector.

### Advantageous Effects of Invention

According to the present disclosure, it is possible to provide a camera calibration apparatus, a camera calibration method, and a non-transitory computer readable medium storing a camera calibration program that can easily and accurately obtain camera parameters.

### BRIEF DESCRIPTION OF DRAWINGS

FIG. 1 is a flowchart showing a monitoring method according to related art;

FIG. 2 is a configuration diagram showing an overview of a camera calibration apparatus according to example embodiments;

FIG. 3 is a configuration diagram showing a configuration of a camera calibration apparatus according to a first example embodiment;

FIG. 4 is a flowchart showing a camera calibration method according to the first example embodiment;

FIG. 5 is a flowchart showing a skeleton vector calculation method according to the first example embodiment;

FIG. 6 shows a human body model according to the first example embodiment;

FIG. 7 shows an example of detection of a skeletal structure and a skeleton vector according to the first example embodiment;

FIG. 8 is a diagram for explaining a method of aggregating skeleton vectors according to the first example embodiment;

FIG. 9 is a diagram for explaining a method of aggregating skeleton vectors according to the first example embodiment;

FIG. 10 is a flowchart showing a skeleton vector calculation method according to a second example embodiment;

FIG. 11 shows an example of detection of a skeletal structure and a skeleton vector according to the second example embodiment;

FIG. 12 is a flowchart showing a skeleton vector calculation method according to Specific Example 1 of a third example embodiment;

FIG. 13 shows an example of detection of a skeletal structure and a skeleton vector according to Specific Example 1 of the third example embodiment;

FIG. 14 shows a human body model used in Specific Example 2 of the third example embodiment;

FIG. 15 is a flowchart showing a skeleton vector calculation method according to Specific Example 2 of the third example embodiment;

FIG. 16 shows an example of detection of a skeletal structure according to Specific Example 2 of the third example embodiment;

FIG. 17 is a histogram for explaining a skeleton vector calculation method according to Specific Example 2 of the third example embodiment;

FIG. 18 is a flowchart showing a skeleton vector calculation method according to Specific Example 3 of the third example embodiment;

FIG. 19 shows an example of detection of a skeletal structure according to Specific Example 3 of the third example embodiment;

FIG. 20 shows a three-dimensional human body model according to Specific Example 3 of the third example embodiment;

FIG. 21 is a diagram for explaining the skeleton vector calculation method according to Specific Example 3 of the third example embodiment;

FIG. 22 is a diagram for explaining the skeleton vector calculation method according to Specific Example 3 of the third example embodiment;

FIG. 23 is a diagram for explaining the skeleton vector calculation method according to Specific Example 3 of the third example embodiment; and

FIG. 24 is a configuration diagram showing an overview of hardware of a computer according to example embodiments.

### DESCRIPTION OF EMBODIMENTS

Example embodiments will be described below with reference to the drawings. In each drawing, the same elements are denoted by the same reference signs, and the repeated description is omitted if necessary.

### (Study Leading to Example Embodiments)

Recently, image recognition technology utilizing machine learning has been applied to various systems. As an example, a monitoring system for performing monitoring using images captured by a monitoring camera will be discussed.

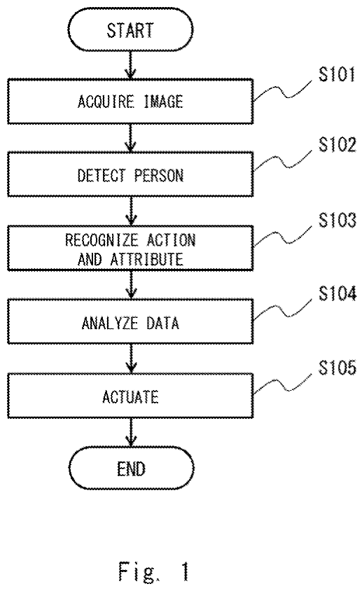

FIG. 1 shows a monitoring method performed by a monitoring system according to related art. As shown in FIG. 1, the monitoring system acquires an image from the monitoring camera (S101), detects a person from the acquired image (S102), and performs action recognition and attribute recognition of the person (S103). For example, a behavior and a movement line of the person are recognized as the actions of the person, and age, gender, height, etc. of the person are recognized as the attributes of the person. Further, the monitoring system performs data analysis on the recognized actions and attributes of the person (S104), and actuation such as processing based on an analysis result or the like is performed (S105). For example, the monitoring system displays an alert from the recognized actions, and the attribute such as the recognized height of the person is monitored.

As shown in this example, there is a growing demand for detecting behaviors and attributes of a person (an individual and crowds) from images or videos of a monitoring camera. For example, information obtained by counting the number of people passing through a store and the like from the detected behaviors of persons is utilized for acquiring congestion and marketing. Information about a height estimated as an attribute of a person, for example, is utilized for search of a lost child and marketing.

In order to perform such image recognition, it is necessary to convert a length of an object and a speed of a movement of an object in an image into values in the real world. For this purpose, a technique utilizing camera parameters (camera posture, focal length, etc.) is used. The inventor has studied a calibration method for obtaining camera parameters from an image of a camera, and have found that related techniques are complicated and costly, and that the camera parameters cannot always be calculated with high accuracy. For example, although it is possible to obtain camera parameters by capturing an image of an object having a known three-dimensional height or by inputting position information and the like of an object having a known three-dimensional position in an image, preparation of such an object and input of information are complicated, and it is difficult to easily obtain the camera parameters. Further, a method of specifying a person area from an image by utilizing a technique such as a background difference and obtaining camera parameters by using information such as a direction in which a person is standing upright and a height is simple. However, in such a method, if a part of the person's body is hidden, for example, the camera parameters may not be obtained from the information about the detected person.

Therefore, the inventors studied a method using a skeleton estimation technique by means of machine learning for camera calibration. For example, in a skeleton estimation technique according to related art such as OpenPose disclosed in Non Patent Literature 1, a skeleton of a person is estimated by learning various patterns of annotated image data. In the following example embodiments, the cost can be reduced, and the camera parameters can be accurately obtained by utilizing such a skeleton estimation technique.

The skeletal structure estimated by the skeleton estimation technique such as OpenPose is composed of “key points” which are characteristic points such as joints, and “bones, i.e., bone links” indicating links between the key points. Therefore, in the following example embodiments, the skeletal structure is described using the terms “key point” and “bone”, but unless otherwise specified, the “key point” corresponds to the “joint” of a person, and a “bone” corresponds to the “bone” of the person.

### OVERVIEW OF EXAMPLE EMBODIMENTS

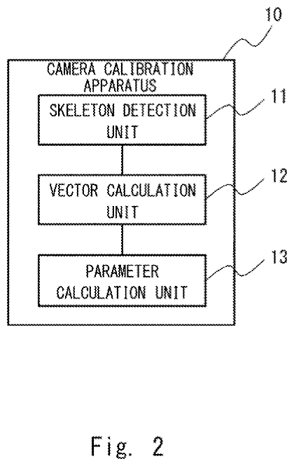

FIG. 2 shows an overview of a camera calibration apparatus 10 according to the example embodiments. As shown in FIG. 2, the camera calibration apparatus 10 includes a skeleton detection unit 11, a vector calculation unit 12, and a parameter calculation unit 13.

The skeleton detection unit 11 detects a two-dimensional skeletal structure of a person based on the two-dimensional image captured by a camera. The vector calculation unit 12 calculates a skeleton vector indicating a direction and a size of a skeleton of the person in the two-dimensional image based on the two-dimensional skeletal structure detected by the skeleton detection unit 11. The parameter calculation unit 13 calculates camera parameters of a camera based on the skeleton vector calculated by the vector calculation unit 12.

Thus, in the example embodiments, a skeletal structure is detected from an image, and the camera parameters are calculated based on the skeleton vector obtained from this skeletal structure. By doing so, it is possible to prevent an increase in the time and effort required for inputting necessary information and to obtain the camera parameters with high accuracy.

### First Example Embodiment

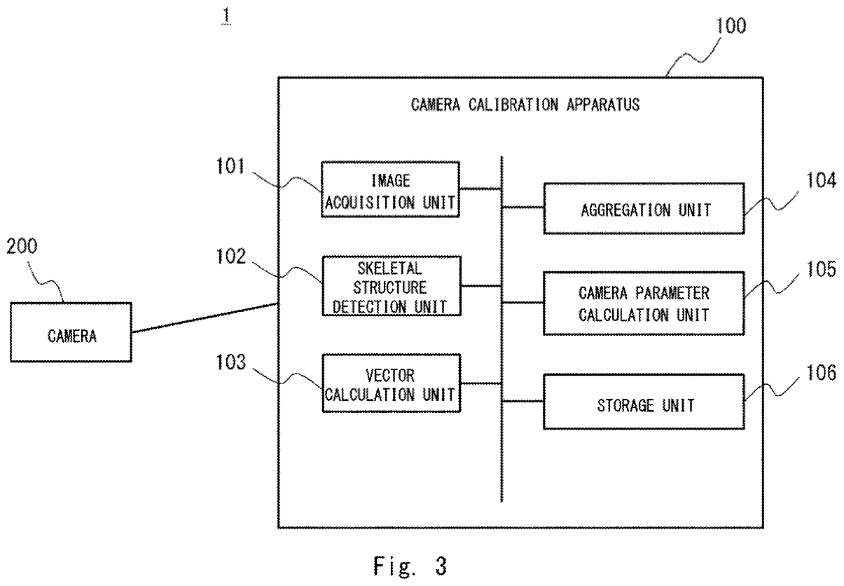

A first example embodiment will be described below with reference to the drawings. FIG. 3 shows a configuration of the camera calibration apparatus 100 according to this example embodiment. The camera calibration apparatus 100 and a camera 200 constitute a camera calibration system 1. For example, the camera calibration apparatus 100 and the camera calibration system 1 are applied to a monitoring method in a monitoring system as shown in FIG. 1, and behaviors and attributes of a person are recognized by using the camera parameters obtained by the camera calibration apparatus 100 and the camera calibration system 1, and an alarm is displayed or the person is monitored according to the recognition result. The camera 200 may be included inside the camera calibration apparatus 100.

As shown in FIG. 3, the camera calibration apparatus 100 includes an image acquisition unit 101, a skeletal structure detection unit 102, a vector calculation unit 103, an aggregation unit 104, a camera parameter calculation unit 105, and a storage unit 106. A configuration of each unit, i.e., each block, is an example, and may be composed of other units, as long as the method or an operation described later is possible. Further, the camera calibration apparatus 100 is implemented by, for example, a computer apparatus such as a personal computer or a server for executing a program, and instead may be implemented by one apparatus or a plurality of apparatuses on a network.

The storage unit 106 stores information and data necessary for the operation and processing of the camera calibration apparatus 100. For example, the storage unit 106 may be a non-volatile memory such as a flash memory or a hard disk apparatus. The storage unit 106 stores images acquired by the image acquisition unit 101, images processed by the skeletal structure detection unit 102, data for machine learning, data aggregated by the aggregation unit 104, and statistical values (e.g., average values) of the height of the person and the length of each bone. The statistical values of the height of the person and the length of each bone may be prepared for each attribute of the person such as age, gender, and nationality. The storage unit 106 may be an external storage device or an external storage device on the network. That is, the camera calibration apparatus 100 may acquire necessary images, data for machine learning, statistical values of the height of a person, and the like from an external storage device, or may output data of an aggregated result, and the like, to the external storage device.

The image acquisition unit 101 acquires a two-dimensional image captured by the camera 200 from the camera 200 which is connected to the camera calibration apparatus 100 in a communicable manner. The camera 200 is an imaging unit such as a monitoring camera installed at a predetermined position for capturing a person in an imaging area from the installed position. The image acquisition unit 101 acquires, for example, a plurality of images (videos) including a person captured by the camera 200 in a predetermined period of time.

The skeletal structure detection unit 102 detects a two-dimensional skeletal structure of the person in the image based on the acquired two-dimensional image. The skeletal structure detection unit 102 detects the skeletal structure of the person based on the characteristics such as joints of the person to be recognized using a skeleton estimation technique by means of machine learning. The skeletal structure detection unit 102 detects the skeletal structure of the person to be recognized in each of the plurality of images. The skeletal structure detection unit 102 uses, for example, the skeleton estimation technique such as OpenPose of Non Patent Literature 1.

The vector calculation unit 103 calculates a skeleton vector of the person in the two-dimensional image based on the detected two-dimensional skeletal structure. The vector calculation unit 103 calculates the skeleton vector for each of a plurality of skeletal structures in the plurality of detected images. The skeleton vector is a vector indicating a direction (a direction from the feet to the head) and a size of the skeletal structure of the person. The direction of the vector is a two-dimensional slope in the two-dimensional image, and the size of the vector is a two-dimensional length (pixel count) in the two-dimensional image. The skeleton vector may be a vector corresponding to a bone included in the detected skeletal structure or a vector corresponding to a central axis of the skeletal structure. For example, the central axis of the skeletal structure can be obtained by performing a PCA (Principal Component Analysis) on the information about the detected skeletal structure. The skeleton vector may be a vector based on the whole skeletal structure of a person or a vector based on a part of the skeletal structure of a person. In this example embodiment, a skeleton vector based on foot bones (bones of the foot part) of the skeletal structure is used as the part of the skeletal structure of the person. That is, the vector calculation unit 103 obtains the direction and length of the foot bone from the information about the detected skeletal structure to obtain the skeleton vector of a foot. Note that, as the part of the skeletal structure of the person, the direction and length of the bone may be obtained not only from a foot but also from other parts. Since the skeleton vector is preferably more perpendicular to the ground, for example, the directions and lengths of the bones of the torso or head may be used in addition to the foot bones. Further, as the size of the skeleton vector, not only the length of the bone of each part but also the height (the length of the whole body) estimated from the bone of each part may be used.

The aggregation unit 104 aggregates the plurality of calculated skeleton vectors. The aggregation unit 104 aggregates the plurality of skeleton vectors based on the plurality of skeletal structures of the plurality of images captured in the predetermined period of time. The aggregation unit 104 obtains, for example, an average value of the plurality of skeleton vectors in aggregation processing. That is, the aggregation unit 104 obtains an average value of the directions and lengths of the skeleton vectors based on the foot bones of the skeletal structures. Note that other statistical values, such as intermediate values of the plurality of skeleton vectors, may be obtained in addition to the average values of the skeleton vectors.

The camera parameter calculation unit 105 calculates camera parameters based on the aggregated skeleton vectors. The camera parameters are imaging parameters of the camera 200 and are parameters for converting the length in the two-dimensional image captured by the camera 200 into the length in a three-dimensional real world. For example, the camera parameters include internal parameters such as a focal length of the camera 200 and external parameters such as a posture (imaging angle), a position, and the like of the camera 200. The camera parameter calculation unit 105 calculates the camera parameters based on the length of the skeleton vector (the length in the direction perpendicular to the ground) and reference values of the height of the person and the length of the bone of the person stored in the storage unit 106 (statistical values such as average values). The camera parameter calculation unit 105 calculates the camera parameters by using, for example, the calibration method described in Patent Literature 1.

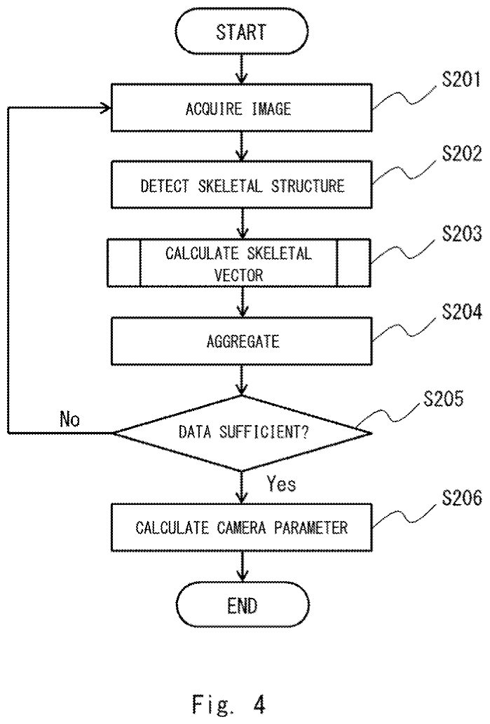

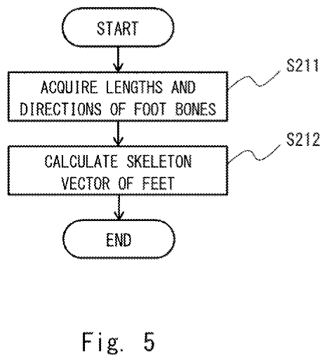

FIGS. 4 and 5 show the operation of the camera calibration apparatus 100 according to this example embodiment. FIG. 4 shows a flow from image acquisition to the calculation of the camera parameters in the camera calibration apparatus 100. FIG. 5 shows a flow of skeleton vector calculation processing (S203) in FIG. 4.

As shown in FIG. 4, the camera calibration apparatus 100 acquires an image from the camera 200 (S201). The image acquisition unit 101 acquires the image obtained by capturing a person for calculating the camera parameters.

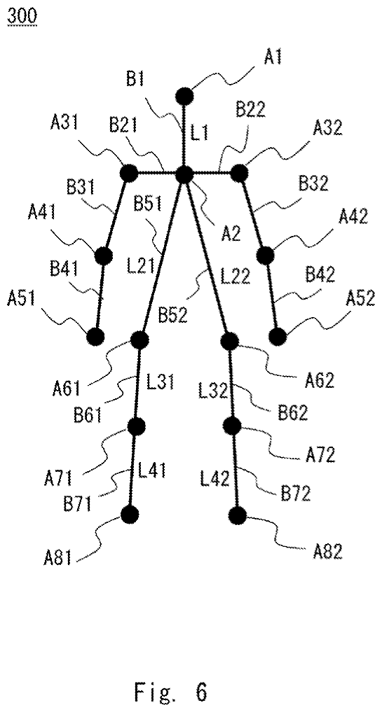

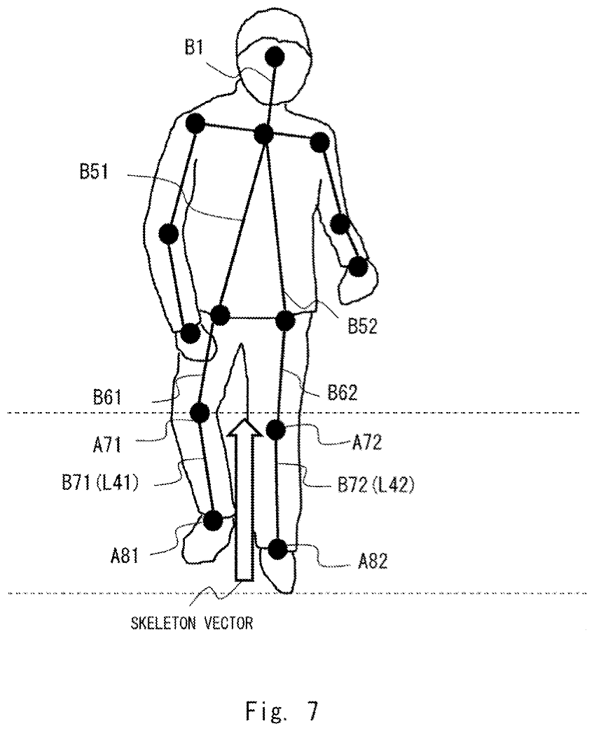

Next, the camera calibration apparatus 100 detects the skeletal structure of the person based on the acquired image of the person (S202). FIG. 6 shows the skeletal structure of a human body model 300 detected at this time. FIG. 7 shows examples of detection of the skeletal structure. The skeletal structure detection unit 102 detects the skeletal structure of the human body model 300, which is a two-dimensional skeleton model, shown in FIG. 6 from the two-dimensional image by the skeleton estimation technique such as OpenPose. The human body model 300 is a two-dimensional model composed of key points such as joints of a person and bones connecting the key points.

The skeletal structure detection unit 102 extracts, for example, characteristic points that can be the key points from the image, and detects each key point of the person by referring to information obtained by machine learning the image of the key point. In the example of FIG. 6, as the key points of a person, a head A1, a neck A2, a right shoulder A31, a left shoulder A32, a right elbow A41, a left elbow A42, a right hand A51, a left hand A52, a right hip A61, a left hip A62, a right knee A71, a left knee A72, a right foot A81, and a left foot A82 are detected. Further, as the bones of the person connecting these key points, a bone B1 connecting the head A1 to the neck A2, bones B21 and B22 respectively connecting the neck A2 to the right shoulder A31 and the neck A2 to the left shoulder A32, bones B31 and B32 respectively connecting the right shoulder A31 to the right elbow A41 and the left shoulder A32 to the left elbow A42, bones B41 and B42 respectively connecting the right elbow A41 to the right hand A51 and the left elbow A42 to the left hand A52, bones B51 and B52 respectively connecting the neck A2 to the right hip A61 and the neck A2 to the left hip A62, bones B61 and B62 respectively connecting the right hip A61 to the right knee A71 and the left hip A62 to the left knee A72, bones B71 and B72 respectively connecting the right knee A71 to the right foot A81 and the left knee A72 to the left foot A82 are detected.

FIG. 7 shows an example in which a person standing upright is detected and the person standing upright is captured from the front. In FIG. 7, all the bones from the bone B1 of the head to the bone B71 and B72 of the feet as viewed from the front are detected. In this example, the bone B61 and the bone B71 of the right foot are slightly more bent than the bone B62 and the bone B72 of the left foot, respectively.

Next, the camera calibration apparatus 100 performs the skeleton vector calculation processing based on the detected skeletal structure (S203). In the skeleton vector calculation processing, as shown in FIG. 5, the vector calculation unit 103 acquires the lengths and directions of the foot bones (S211), and calculates the skeleton vector of the feet (S212). The vector calculation unit 103 acquires the lengths (pixel counts) and the directions (slopes) of the foot bones of the person in the two-dimensional image to obtain the skeleton vector of the feet.

For example, as shown in FIG. 7, the lengths and directions of the bone B71 (length L41) and the bone B72 (length L42) are acquired from the image in which the skeletal structure is detected as the foot bones among the bones of the whole body. The length and direction of each bone can be obtained from the coordinates of each key point in the two-dimensional image. The lengths and directions of both the bone B71 on the right foot side and the bone B72 on the left foot side may be acquired, or the length and direction of either of the bone B71 or B72 may be acquired. When only the length and direction of one of these bones can be calculated, the calculated length and direction of the bone are used as the skeleton vector. When the length and direction of both the bone B71 and the bone B72 can be calculated, the central axes of the calculated lengths and directions of the bones may be used as the skeleton vector, or the length and direction of either of the bone B71 or the bone B72 may be selected to be used as the skeleton vector. For example, the central axis obtained by the PCA analysis or the average of the two vectors may be used as the skeleton vector, or the longer one of the vectors may be used as the skeleton vector.

In the example of FIG. 7, the bone B61 and the bone B71 of the right foot are detected to be bent slightly more than the bone B62 and the bone B72 of the left foot, and the bone B72 of the left foot is longer and is more perpendicular to the ground than the bone B71 of the right foot. For example, vectors of the central axis (average) of the bone B71 (key points A71 to A81) and the bone B72 (key points A72 to A82) are used as the skeleton vector, or the length and direction of the bone B72 (key points A72 to A82) on the left foot side, which the bone is longer and more perpendicular to the ground than the bone on the right foot side, are used as the skeleton vector.

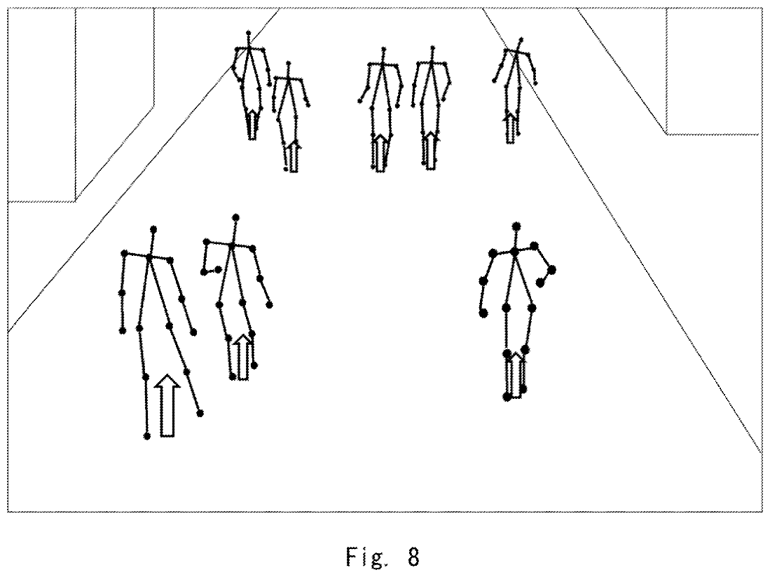

Next, as shown in FIG. 4, the camera calibration apparatus 100 aggregates the plurality of calculated skeleton vectors (S204), and repeats processing of acquiring the image and aggregating the skeleton vectors (S201 to S204) until sufficient data is obtained (S205). For example, as shown in FIG. 8, the aggregation unit 104 aggregates skeleton vectors from skeletal structures of persons detected at a plurality of positions in an image. In the example shown in FIG. 8, a plurality of persons are passing through at the center of the image, and skeleton vectors of the feet substantially perpendicular to the ground are detected from the skeletal structures of the plurality of walking persons, and are aggregated.

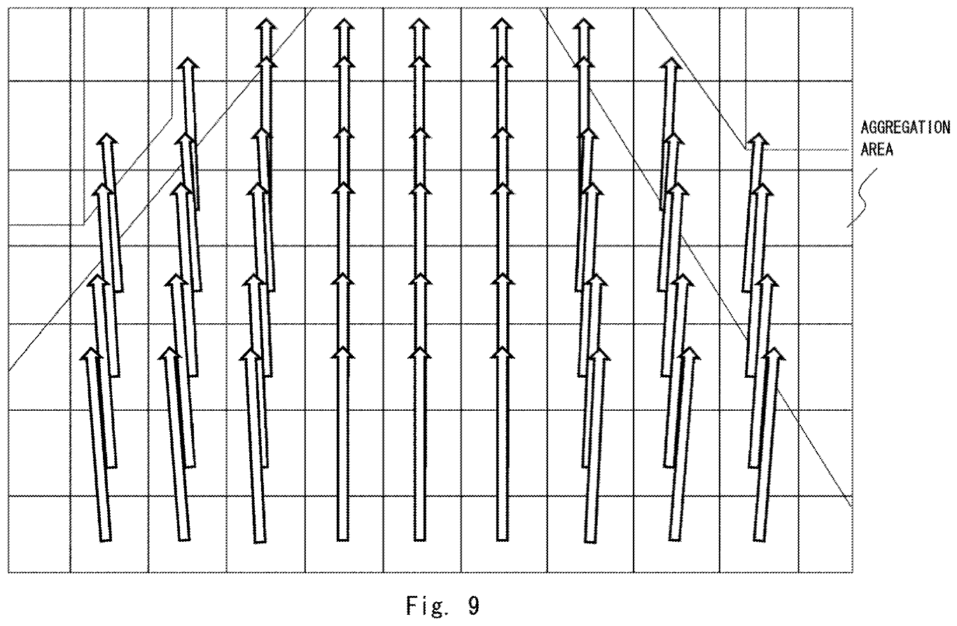

The aggregation unit 104 divides the image shown in FIG. 8 into a plurality of aggregation areas as shown in FIG. 9, and aggregates the skeleton vectors for each aggregation area. For example, the aggregation area is a rectangular area obtained by dividing an image at predetermined intervals in the vertical and horizontal directions. The aggregation area is not limited to a rectangle and instead may be any shape. The aggregation area is divided at predetermined intervals without considering the background of the image. Note that the aggregation area may be divided in consideration of the background of the image, the amount of aggregated data, and the like. For example, the area (an upper side of the image), which is far from the camera, may be made smaller than the area (a lower side of the image), which is close to the camera, according to an imaging distance so as to correspond to the relationship between the image and the size of the real world. Further, an area having more skeleton vectors than those of another area may be made smaller than an area having fewer skeleton vectors according to the amount of data to be aggregated.

For example, skeleton vectors of persons whose feet (for example, lower ends of the feet) are detected in an aggregation area are aggregated for each aggregation area. When a part other than a foot is detected, the part other than the foot may be used as a reference for aggregation. For example, skeleton vectors of persons whose heads or torsos are detected in the aggregation area may be aggregated for each aggregation area.

In order to calculate the camera parameters with high accuracy, it is preferable to detect skeleton vectors in a plurality of aggregation areas and aggregate the skeleton vectors in each area. More camera parameters can be obtained by using skeleton vectors of more aggregation areas. For example, all camera parameters such as a posture, a position, and a focal length can be obtained by the skeleton vectors of three or more areas. Further, the calculation accuracy of the camera parameters can be improved by aggregating more skeleton vectors for each aggregation area. For example, it is preferable to aggregate three to five skeleton vectors for each aggregation area to obtain an average thereof. By obtaining the average of the plurality of skeleton vectors, a vector in a direction more perpendicular to the ground in the aggregation area can be obtained. Although the calculation accuracy can be improved by increasing the number of the aggregation areas and the amount of the aggregated data, the calculation processing requires time and increases cost. By reducing the number of the aggregation areas and the amount of aggregated data, the calculation can be easily performed, but the calculation accuracy may be reduced. Therefore, it is preferable to determine the number of the aggregation areas and the amount of aggregated data in consideration of the required calculation accuracy and the cost.

Next, as shown in FIG. 4, when the sufficient amount of data is aggregated, the camera calibration apparatus 100 calculates the camera parameters based on the aggregated skeleton vectors (S206). The camera parameter calculation unit 105 uses the lengths of the skeleton vectors of the feet as the lengths in the two-dimensional image to obtain the camera parameters by using an average value of the lengths of the foot bones of persons as a length in the three-dimensional real world. That is, the camera parameters are obtained on the assumption that an aggregated value of the lengths of the skeleton vectors of the feet in the two-dimensional image is equal to the average value of the lengths of the bones of the feet in the three-dimensional real world. Note that the average value to be referred to is a common average value of a person, and instead the average value to be referred to may be selected according to attributes of a person such as age, gender, nationality, and the like. For example, when a face of a person appears in the captured image, an attribute of the person is identified based on the face, and an average value corresponding to the identified attribute is referred to. By referring to the information obtained by machine learning the face for each attribute, the attribute of the person can be recognized from the characteristics of the face of the image. When the attribute of the person cannot be identified from the image, the common average value may be used.

For example, in a manner similar to the method described in Patent Literature 1, a skeleton vector is projected onto a projection plane perpendicular to the ground (reference plane), and camera parameters are obtained based on the perpendicularity of the projected skeleton vector with respect to the ground. By evaluating the perpendicularity of the skeleton vector projected on the projection plane, the posture (rotation matrix) of the camera can be obtained. The position (translation matrix) and the focal length of the camera can be obtained from a difference between the length obtained by projecting the skeleton vector of the two-dimensional image onto the three-dimensional space and the average value of the heights of the persons and the lengths of the bones (in this example, the lengths of the foot bones) in the three-dimensional real world by using the posture of the camera.

As described above, in this example embodiment, skeletal structures of persons are detected from a two-dimensional image, skeleton vectors are obtained based on bones such as feet, which are parts of the detected skeletal structures, and the skeleton vectors are further aggregated to calculate camera parameters. Since the skeletal structures of the persons are detected and the calibration is automatically performed, it is not necessary to manually input information from the outside, the camera parameters can be easily calculated, and the cost for the calibration can be reduced. In addition, since it is sufficient to detect at least the skeleton necessary for the skeleton vector by the skeleton estimation technique by means of machine learning, the camera parameters can be calculated with high accuracy even when the whole body of the person does not necessarily appear in the image.

### Second Example Embodiment

Next, a second example embodiment will be described. In this example embodiment, in the skeleton vector calculation processing according to the first example embodiment, the skeleton vector is obtained based on a plurality of bones as parts of a skeletal structure of a person. The processing other than the skeleton vector calculation processing is the same as that of the first example embodiment.

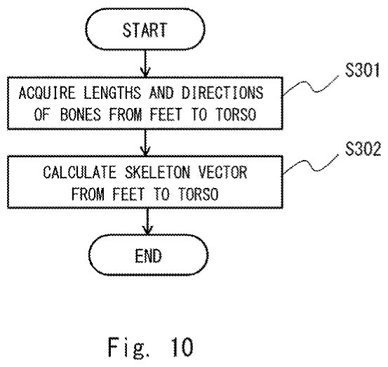

FIG. 10 shows the skeleton vector calculation processing according to this example embodiment and shows a flow of the skeleton vector calculation processing (S203) of FIG. 4 according to the first example embodiment. In the skeleton vector calculation processing according to this example embodiment, as shown in FIG. 10, the vector calculation unit 103 acquires the lengths and directions of the bones from the feet to the torso (S301), and calculates the skeleton vector from the feet to the torso (S302). Note that in this example, the skeleton vector is obtained based on the bones from the feet (foot parts) to the torso (torso part) as the plurality of bones. Alternatively, the skeleton vector may be obtained based on, for example, the bones from the torso (torso part) to the head part.

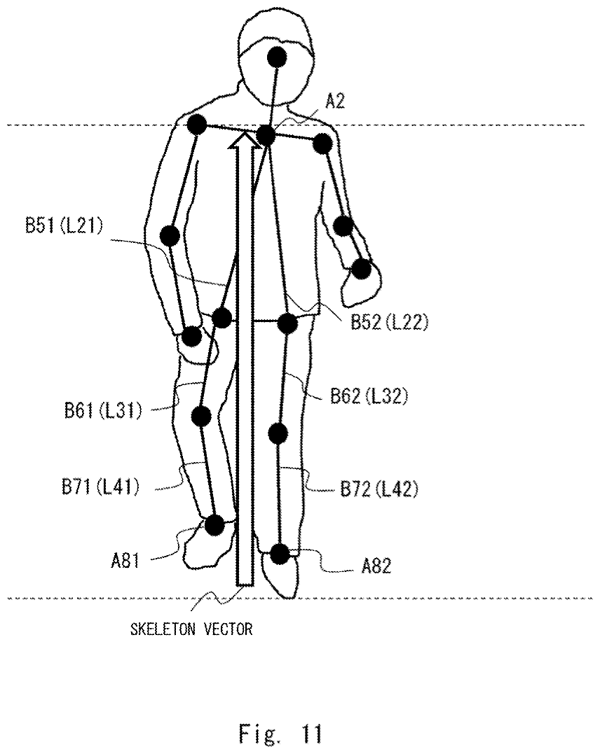

For example, as shown in FIG. 11, the lengths (pixel counts) and directions of the bones B51 (length L21), B61 (length L31), and B71 (length L41), and the bones B52 (length L22), B62 (length L32), and B72 (length L42) are acquired from the image in which the skeletal structure is detected, as the bones from the feet to the torso among the bones of the whole body.

The sum of the lengths of the bones, L21+L31+L41 and L22+L32+L42, may be a total length of the right and left sides, respectively, of the whole body, or a length of a line connecting the highest coordinates of the bone of the torso and the lowest coordinates of the bone of the foot may be the total length of the whole body. The direction may also be obtained by using the average (central axis) of the directions of the bones on the right side of the body and the average of the bones on the left side of the body, or by using the direction of a line connecting the highest coordinates of the bone of the torso and the lowest coordinates of the bone of the foot.

As in the first example embodiment, the lengths and directions of the bones B51, B61, and B71 on the right side of the body and the bones B52, B62, and B72 on the left side of the body may be obtained, or the lengths and directions of the bones on either the right side or left side may be obtained. When only the lengths and directions of the bones on either the right or the left side of the body can be calculated, the calculated lengths and directions of the bones are used as the skeleton vector. When the lengths and directions of the bones on the both sides can be calculated, the central axes of the calculated lengths and directions of the bones may be used as the skeleton vector, or the length and direction of the bones on either side may be selected to be used as the skeleton vector.

In the example of FIG. 11, the bones B61 and B71 of the right foot are detected to be bent slightly more than the bones B62 and B72 of the left foot, and the bones B52, B62, and B72 of the left side of the body are longer and more perpendicular to the ground than the bones B51, B61, and B71 of the right side of the body. For example, vectors of the central axis (average) of the bones B51, B61, and B71 (key points A2 to A81) and the bones B52, B62, and B72 (key points A2 to A82) are used as the skeleton vector, or vectors of the bones B52, B62, and B72 (key points A2 to A82) on the left foot side of the body, which the bones are longer and more perpendicular to the ground than the bones on the right foot side, are used as the skeleton vector.

As described above, in this example embodiment, the skeleton vector is obtained based on bones from, for example, the feet to the torso, which are parts of the detected skeletal structure, and the skeleton vectors are further aggregated to calculate the camera parameters. When a skeleton vector is obtained from only one bone such as a foot bone as in the first example embodiment, the skeleton vector may be inclined with respect to the ground. On the other hand, as in this example embodiment, by obtaining a skeleton vector from a plurality of bones from, for example, feet to a torso, the skeleton vector can be made more perpendicular to the ground, and thus camera parameters can be obtained more accurately.

### Third Example Embodiment

Next, a third example embodiment will be described. In this example embodiment, in the skeleton vector calculation processing according to the first example embodiment, the skeleton vector of the whole body is obtained based on the whole skeletal structure of the person (the skeletal structure of the whole body). Other configurations according to the third example embodiment are the same those according to the first example embodiment. Hereinafter, Specific Examples 1 to 3 in which a length of a whole body of a person (which is referred to as a height pixel count) is a length of a skeleton vector of a whole body will be described.

### Specific Example 1

In Specific Example 1 of this example embodiment, a skeleton vector of a whole body is obtained based on bones from the head part to the foot part. In particular, the lengths of the bones from the head part to the foot part are used to obtain the height pixel count.

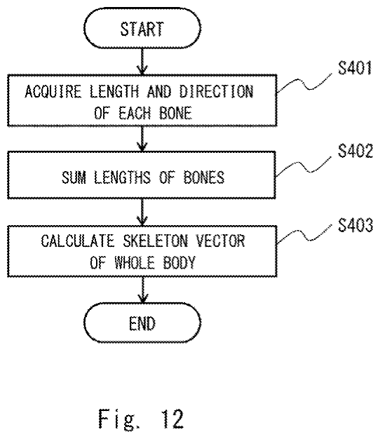

FIG. 12 shows the skeleton vector calculation processing according to Specific Example 1 and shows a flow of the skeleton vector calculation processing (S203) of FIG. 4 according to the first example embodiment. In the skeleton vector calculation processing of Specific Example 1, as shown in FIG. 12, the vector calculation unit 103 acquires the length and direction of each bone of the whole body (S401), sums the lengths of the acquired bones (S402), and calculates the skeleton vector of the whole body by using the summed height pixel count (S403).

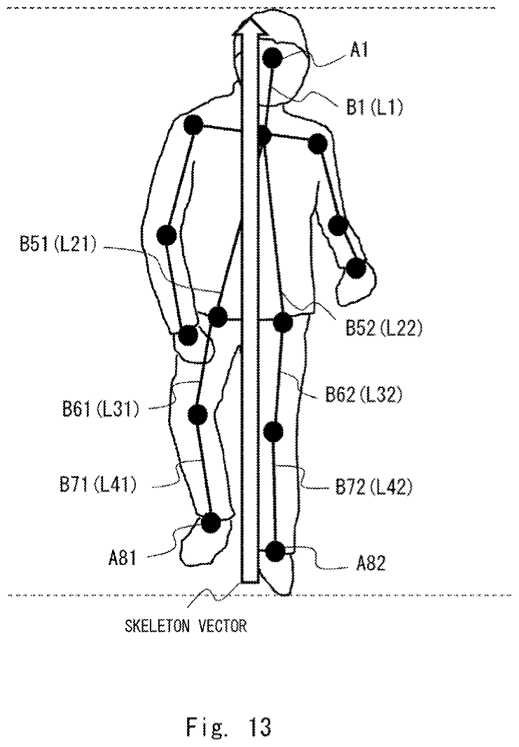

For example, as shown in FIG. 13, the lengths (pixel counts) and directions of the bones B1 (length L1), B51 (length L21), B61 (length L31), and B71 (length L41), and the bones B1 (length L1), B52 (length L22), B62 (length L32), and B72 (length L42) are acquired from the image in which the skeletal structure is detected, as the bones of the whole body.

As in the second example embodiment, the sum of the lengths of the bones, L1+L21+L31+L41 and L1+L22+L32+L42, may be a total length of the body on the right and left sides, respectively, of the whole body (height pixel count), or a length of a line connecting the highest coordinates of the bone of the head and the lowest coordinates of the bone of the torso may be the total length of the whole body. Also in a manner similar to the second example embodiment, the direction may be obtained by using the average (central axis) of the directions of the bones on the right side of the body and the average of the bones on the left side of the body, or by using the direction of a line connecting the highest coordinates of the bone of the head and the lowest coordinates of the bone of the foot.

As in the first and second example embodiments, the lengths and directions of the bones B1, B51, B61, and B71 on the right side of the body and the bones B1, B52, B62, and B72 on the left side of the body may be used as the skeleton vector, or the lengths and directions of the bones on either the right side or left side may be used as the skeleton vector.

In the example of FIG. 13, the bones B61 and B71 of the right foot are detected to be bent slightly more than the bones B62 and B72 of the left foot, and the bones B1, B52, B62, and B72 of the left side of the body are longer and more perpendicular to the ground than the bones B1, B51, B61, and B71 of the right side of the body. For example, vector of the central axis (average) of the bones B1, B51, B61, and B71 (key points AA1 to A81) and the bones B1, B52, B62, and B72 (key points AA1 to A82) are used as the skeleton vector, or vectors of the bones B1, B52, B62, and B72 (key points A1 to A82) on the left foot side of the body, which the bones are longer and more perpendicular to the ground than the bones on the right foot side, are used as the skeleton vector.

### Specific Example 2

In Specific Example 2 of this example embodiment, a skeleton vector of a whole body is obtained based on some of bones of a skeletal structure. In particular, a height pixel count is obtained by using a two-dimensional skeleton model indicating a relationship between lengths of bones included in a two-dimensional skeletal structure and a length of the whole body of a person in a two-dimensional image space.

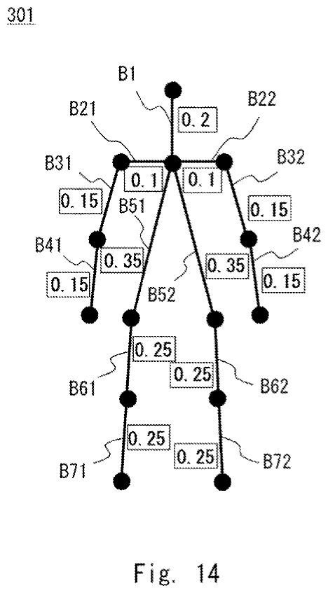

FIG. 14 shows a human body model 301, i.e., a two-dimensional skeleton model, showing the relationship between the length of each bone in the two-dimensional image space and the length of the whole body in the two-dimensional image space used in Specific Example 2. As shown in FIG. 14, the relationship between the length of each bone of an average person and the length of the whole body, which is a ratio of the length of each bone to the length of the whole body, is associated with each bone of the human body model 301. For example, the length of the bone B1 of the head is the total length×0.2 (20%), the length of the bone B41 of the right hand is the total length×0.15 (15%), and the length of the bone B71 of the right foot is the total length×0.25 (25%). By storing such information of the human body model 301 in the storage unit 106, the average length of the whole body, i.e., the pixel count, can be obtained from the length of each bone. In addition to a human body model of an average person, a human body model may be prepared for each attribute of the person such as age, gender, nationality, etc. By doing so, the length, namely, the height, of the whole body can be appropriately obtained according to the attribute of the person.

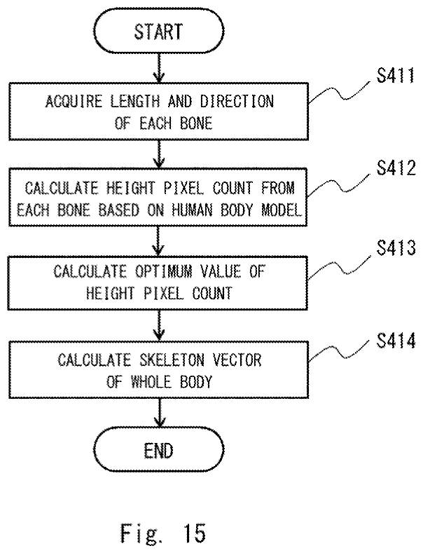

FIG. 15 shows processing for calculating the skeleton vector according to Specific Example 2, and shows a flow of the skeleton vector calculation processing (S203) shown in FIG. 4 according to the first example embodiment. In the skeleton vector calculation processing according to Specific Example 2, as shown in FIG. 15, the skeleton vector calculation unit 103 acquires the length and direction of each bone (S411). In the skeletal structure detected as in Specific Example 1, the skeleton vector calculation unit 103 acquires the lengths of all bones, which are the lengths of the bones in the two-dimensional image space.

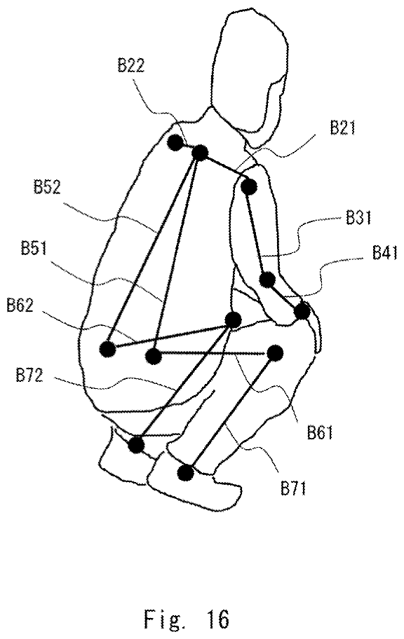

FIG. 16 shows an example in which the skeletal structure is detected by capturing an image of a person crouching down from diagonally backward right. In this example, the bone of the head and the bones of the left arm and the left hand cannot be detected, because the face and the left side of the person do not appear in the image. Therefore, the lengths and directions of the detected bones B21, B22, B31, B41, B51, B52, B61, B62, B71, and B72 are acquired.

Next, the skeleton vector calculation unit 103 calculates the height pixel count from the length of each bone based on the human body model (S412). The skeleton vector calculation unit 103 obtains the height pixel count from the length of each bone with reference to the human body model 301 showing the relationship between each bone and the length of the whole body as shown in FIG. 14. For example, since the length of the bone B41 of the right hand is the length of the whole body×0.15, the height pixel count based on the bone B41 is obtained by calculating the length of the bone B41/0.15. Further, since the length of the bone B71 of the right foot is the length of the whole body×0.25, the height pixel count based on the bone B71 is obtained by calculating the length of the bone B71/0.25.

The human body model to be referred to here is, for example, a human body model of an average person, but the human body model may be selected according to the attributes of the person such as age, gender, nationality, etc. For example, when a face of a person appears in the captured image, an attribute of the person is identified based on the face, and a human body model corresponding to the identified attribute is referred to. By referring to the information obtained by machine learning the face for each attribute, the attribute of the person can be recognized from the characteristics of the face of the image. When the attribute of the person cannot be identified from the image, a human body model of an average person may be used.

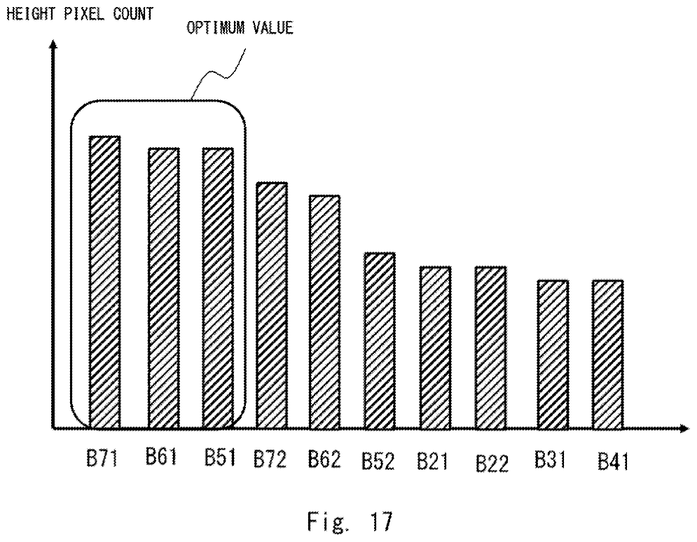

Next, the vector calculation unit 103 calculates an optimum value of the height pixel count (S413). The vector calculation unit 103 calculates the optimum value of the height pixel count from the height pixel count obtained for each bone. For example, as shown in FIG. 17, a histogram of the height pixel count obtained for each bone is generated, and a large height pixel count is selected from the histogram. That is, among the plurality of height pixel counts obtained based on the plurality of bones, the height pixel count larger than the others is selected. For example, the top 30% height pixel counts are defined as valid values. In such a case, in FIG. 17, the height pixel counts calculated based on the bones B71, B61, and B51 are selected. The average of the selected height pixel counts may be obtained as the optimum value, or the maximum height pixel count may be used as the optimum value. Since the height is obtained from the length of the bone in the two-dimensional image, when the image of the bone is not captured from the front, that is, when the image of the bone is captured tilted in the depth direction with respect to the camera, the length of the bone becomes shorter than the length of the bone captured from the front. For this reason, a larger height pixel count is more likely to be calculated from the length of the bone captured from the front compared to a smaller height pixel count, and thus the larger height pixel count indicates a more likely value (greater likelihood). Thus, the larger height pixel count is used as the optimum value.

Next, the vector calculation unit 103 calculates the skeleton vector of the whole body based on the obtained height pixel count (S414). In a manner similar to Specific Example 1, the vector calculation unit 103 uses an optimum value of the height pixel count obtained in S413 as the length of the skeleton vector. As for the direction, as in Specific Example 1, the central axis (average) of the plurality of detected bones may be used, or the direction of a line connecting the highest coordinate of the detected bone and the lowest coordinate of the detected bone may be used.

### Specific Example 3

In Specific Example 3 of the third example embodiment, a two-dimensional skeletal structure is fitted to a three-dimensional human body model (three-dimensional skeleton model), and a skeleton vector of a whole body is obtained by using a height pixel count of the fitted three-dimensional human body model.

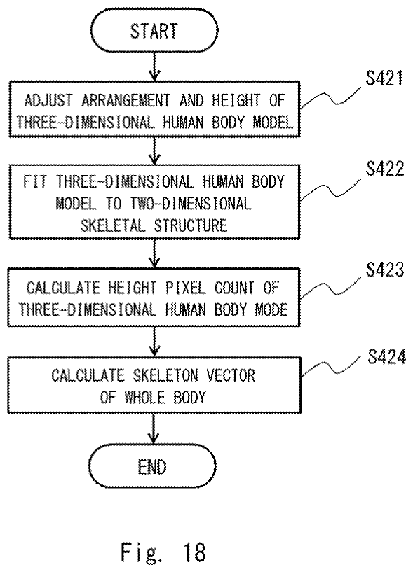

FIG. 18 shows processing for calculating the skeleton vector according to Specific Example 3, and shows a flow of the skeleton vector calculation processing (S203) shown in FIG. 4 according to the first example embodiment. In the skeleton vector calculation processing according to Specific Example 3, as shown in FIG. 18, the vector calculation unit 103 adjusts an arrangement and a height of the three-dimensional human body model (S421).

The vector calculation unit 103 prepares the three-dimensional human body model for calculating the height pixel count for the two-dimensional skeletal structure detected as in Specific Example 1, and disposes the three-dimensional human body model in the same two-dimensional image based on temporary camera parameters. Specifically, an image in which a three-dimensional human body model is projected two-dimensionally is created based on the temporary camera parameters. Next, the image is rotated, enlarged, and reduced and then the image is superimposed on the two-dimensional skeletal structure.

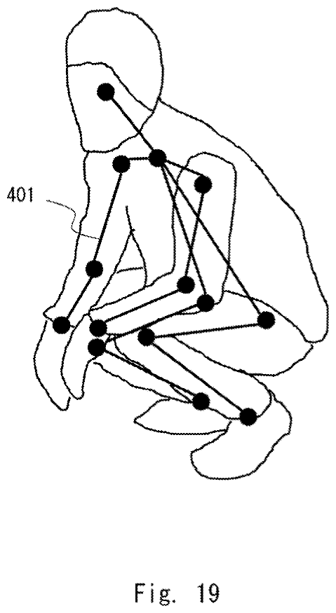

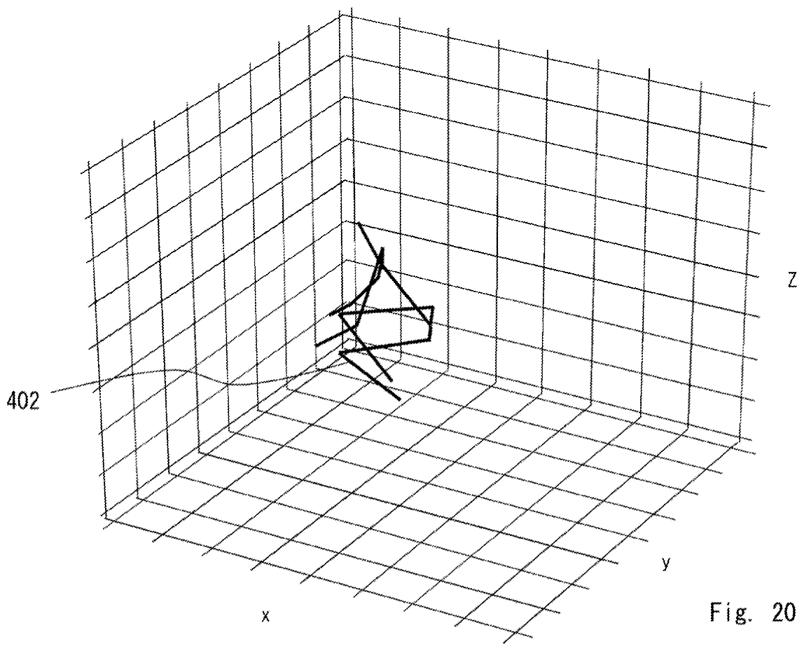

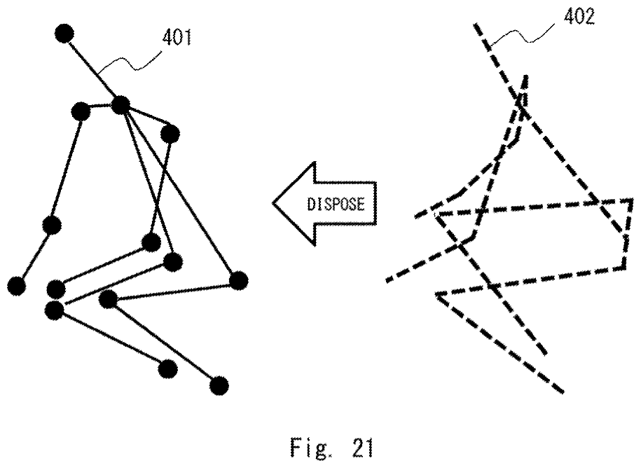

FIG. 19 shows an example in which a person crouching down is captured from diagonally forward left to detect the two-dimensional skeletal structure 401. The two-dimensional skeletal structure 401 has two-dimensional coordinate information. It is preferable that all bones be detected, but some bones may not be detected. A three-dimensional human body model 402 as shown in FIG. 20 is prepared for the two-dimensional skeletal structure 401. The three-dimensional human body model, i.e., three-dimensional skeleton model, 402 has three-dimensional coordinate information and is a skeleton model having the same shape as that of the two-dimensional skeletal structure 401. Next, as shown in FIG. 21, the prepared three-dimensional human body model 402 is disposed and superimposed on the detected two-dimensional skeletal structure 401. The three-dimensional human body model 402 is superimposed and also adjusted so that the height of the three-dimensional human body model 402 fits to the two-dimensional skeletal structure 401.

The three-dimensional human body model 402 prepared here may be a model in a state close to the posture of the two-dimensional skeletal structure 401 as shown in FIG. 21 or a model in an upright state. For example, a technique for estimating the posture of the three-dimensional space from the two-dimensional image using the machine learning may be used to generate the three-dimensional human body model 402 of the estimated posture. By learning the information about the joints of the two-dimensional image and the joints of the three-dimensional space, the three-dimensional posture can be estimated from the two-dimensional image.

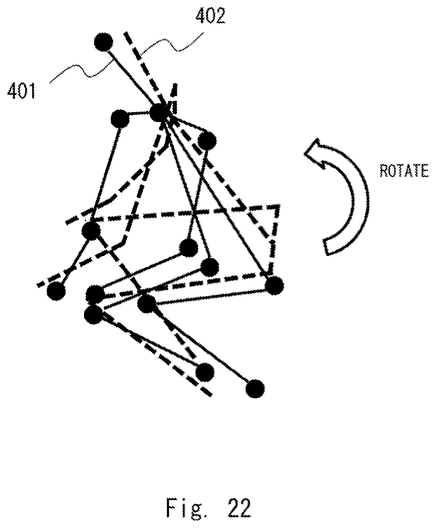

Next, the vector calculation unit 103 fits the three-dimensional human body model to the two-dimensional skeletal structure (S422). As shown in FIG. 22, the vector calculation unit 103 projects the three-dimensional human body model 402 onto the two-dimensional image based on the temporary camera parameters, and changes the temporary camera parameters and the three-dimensional human body model 401 so that the posture of the three-dimensional human body model 402 matches that of the two-dimensional skeletal structure 401 in a state where this image is enlarged, reduced, and rotated and superimposed on the two-dimensional skeletal structure 402. That is, among the temporary camera parameters, a parameter affecting a depression angle of the camera, the height and the orientation of the three-dimensional human body model 402, and the angles of the joints of the three-dimensional human body model 402 are adjusted and optimized so that there is no difference between the three-dimensional human body model 402 and the two-dimensional skeletal structure 401. For example, the joints of the three-dimensional human body model 402 are rotated within a movable range of the person, and the entire three-dimensional human body model 402 is rotated or the entire size thereof is adjusted. The fitting of the three-dimensional human body model and the two-dimensional skeletal structure is performed in a two-dimensional space, i.e., on the two-dimensional coordinates. That is, the three-dimensional human body model is mapped to the two-dimensional space, and the three-dimensional human body model is optimized to the two-dimensional skeletal structure in consideration of how the deformed three-dimensional human body model changes in the two-dimensional space, i.e., on the two-dimensional image.

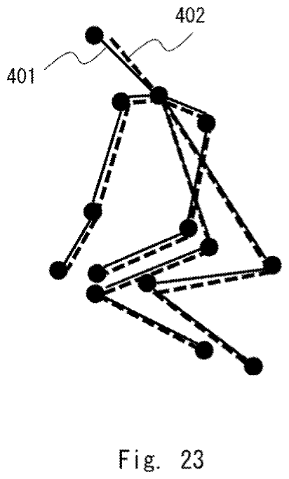

Next, the vector calculation unit 103 calculates the height pixel count of the fitted three-dimensional human body model (S423) and calculates the skeleton vector of the whole body based on the calculated height pixel count (S424). As shown in FIG. 23, when the difference between the three-dimensional human body model 402 and the two-dimensional skeletal structure 401 is eliminated and the posture of the three-dimensional human body model 402 matches the posture of the two-dimensional skeletal structure 401, the vector calculation unit 103 obtains the height pixel count of the three-dimensional human body model 402 in this state. For example, the height pixel count is calculated from the lengths (pixel counts) of the bones from the head to the feet when the three-dimensional human body model 402 is made to stand upright. In a manner similar to Specific Example 1, the lengths of the bones from the head part to the foot part of the three-dimensional human body model 402 may be summed. Further, the vector calculation unit 103 uses the obtained height pixel count as the length of the skeleton vector and obtains the direction of the skeleton vector, in a manner similar to Specific Examples 1 and 2.

As described above, in this example embodiment, the skeleton vector is obtained based on the bones of the whole body of the detected skeletal structure, and the skeleton vector is further aggregated to calculate the camera parameters. Since the skeleton vector can be made more perpendicular to the ground by obtaining the skeleton vector of the whole body, the camera parameters can be obtained more accurately. Further, in Specific Example 1, since the length of the whole body can be obtained by summing the lengths of the bones from the head to the feet, the camera parameters can be calculated by a simple method.

Further, in Specific Example 2, the length of the whole body can be obtained based on the bones of the detected skeletal structure by using the human body model indicating the relationship between the bones in the two-dimensional image space and the length of the whole body. In this way, the camera parameters can be calculated from some of the bones even if the whole skeleton from the head to the feet cannot be obtained. In particular, by employing a greater height from among the heights (height pixel counts) obtained from the plurality of bones, the camera parameters can be calculated accurately.

Further, in Specific Example 3, by fitting the three-dimensional human body model to the two-dimensional skeletal structure based on the temporary camera parameters and obtaining the height pixel count based on the three-dimensional human body model, the height can be accurately estimated and the camera parameters can be calculated even when all the bones do not face the front, that is, even when all the bones are shown diagonally and there is a large difference between actual lengths of the bones, the height can be estimated and the camera parameters can be calculated accurately. When the method according to Specific Examples 1 to 3 can be employed, all of the methods or a combination of the methods may be used to obtain the height pixel count.

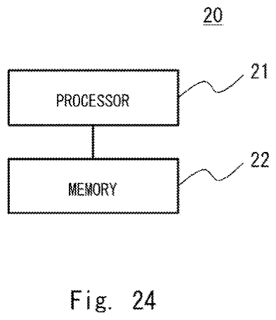

Note that each of the configurations in the above-described example embodiments is constituted by hardware and/or software, and may be constituted by one piece of hardware or software, or may be constituted by a plurality of pieces of hardware or software. The functions and processing of the camera calibration apparatuses 10 and 100 may be implemented by a computer 20 including a processor 21 such as a Central Processing Unit (CPU) and a memory 22 which is a storage device, as shown in FIG. 24. For example, a program, i.e., a camera calibration program, for performing the method according to the example embodiments may be stored in the memory 22, and each function may be implemented by the the processor 21 executing the program stored in the memory 22.

These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Further, the present disclosure is not limited to the above-described example embodiments and may be modified as appropriate without departing from the purpose thereof. For example, although camera parameters are estimated in the above description, camera parameters may be obtained from an image of an animal other than a person having a skeletal structure such as mammals, reptiles, birds, amphibians, fish, etc. may be estimated.

Although the present disclosure has been described above with reference to the example embodiments, the present disclosure is not limited to the example embodiments described above. The configurations and details of the present disclosure may be modified in various ways that would be understood by those skilled in the art within the scope of the present disclosure.

The whole or part of the example embodiments disclosed above can be described as, but not limited to, the following supplementary notes.

### (Supplementary Note 1)

A camera calibration apparatus comprising:
skeleton detection means for detecting a two-dimensional skeletal structure of a person based on a two-dimensional image captured by a camera;
vector calculation means for calculating a skeleton vector based on the detected two-dimensional skeletal structure, the skeleton vector indicating a direction and a size of a skeleton of the person in the two-dimensional image; and
parameter calculation means for calculating a camera parameter of the camera based on the calculated skeleton vector.

### (Supplementary Note 2)

The camera calibration apparatus according to Supplementary note 1, wherein
the skeleton vector is a vector corresponding to a bone included in the two-dimensional skeletal structure or a vector corresponding to a central axis of the two-dimensional skeletal structure.

### (Supplementary Note 3)

The camera calibration apparatus according to Supplementary note 1 or 2, wherein
the skeleton vector is a vector based on a part of the two-dimensional skeletal structure.

### (Supplementary Note 4)

The height estimation apparatus according to Supplementary note 3, wherein
the vector calculation means calculates the skeleton vector based on a bone of a foot part, a torso part, or a head part included in the two-dimensional skeletal structure.

### (Supplementary Note 5)

The camera calibration apparatus according to Supplementary note 3, wherein
the vector calculation means, the skeleton vector, calculates the skeleton vector based on bones from a foot part to a torso part or bones from the torso part to a head part included in the two-dimensional skeletal structure.

### (Supplementary Note 6)

The camera calibration apparatus according to Supplementary note 1 or 2, wherein
the skeleton vector is a vector based on the entire two-dimensional skeletal structure.

### (Supplementary Note 7)

The camera calibration apparatus according to Supplementary note 6, wherein
the vector calculation means calculates the skeleton vector based on a sum of lengths of bones from a foot part to a head part included in the two-dimensional skeletal structure.

### (Supplementary Note 8)

The camera calibration apparatus according to Supplementary note 6, wherein
the vector calculation means calculates the skeleton vector based on a two-dimensional skeleton model indicating a relationship between a length of a bone included in the two-dimensional skeletal structure and a length of a whole body of the person in the two-dimensional image space.

### (Supplementary Note 9)

The camera calibration apparatus according to Supplementary note 6, wherein
the vector calculation means calculates the skeleton vector based on a three-dimensional skeleton model fitted to the two-dimensional skeletal structure.

### (Supplementary Note 10)

The camera calibration apparatus according to any one of Supplementary notes 1 to 9, further comprising:
aggregation means for aggregating a plurality of the calculated skeleton vectors, wherein
the parameter calculation means calculates the camera parameter based on the aggregated skeleton vectors.

### (Supplementary Note 11)

The camera calibration apparatus according to Supplementary note 10, wherein
the aggregation means aggregates the skeleton vectors for each area obtained by dividing the two-dimensional image.

### (Supplementary Note 12)

The camera calibration apparatus according to any one of Supplementary notes 1 to 11, wherein
the parameter calculation means calculates the camera parameter based on the calculated skeleton vector and a reference value of the skeleton of the person.

### (Supplementary Note 13)

The camera calibration apparatus according to Supplementary note 12, wherein
the reference value is a statistical value of the height or the length of the bone of the person.

### (Supplementary Note 14)

The camera calibration apparatus according to Supplementary note 12 or 13, wherein
the reference value is a value corresponding to an attribute of the person.

### (Supplementary Note 15)

A camera calibration method comprising:
detecting a two-dimensional skeletal structure of a person based on a two-dimensional image captured by a camera;
calculating a skeleton vector based on the detected two-dimensional skeletal structure, the skeleton vector indicating a direction and a size of a skeleton of the person in the two-dimensional image; and
calculating a camera parameter of the camera based on the calculated skeleton vector.

### (Supplementary Note 16)

The camera calibration apparatus according to Supplementary note 15, wherein
the skeleton vector is a vector corresponding to a bone included in the two-dimensional skeletal structure or a vector corresponding to a central axis of the two-dimensional skeletal structure.

### (Supplementary Note 17)

A non-transitory computer readable medium storing a camera calibration program for causing a computer to execute processing of:
detecting a two-dimensional skeletal structure of a person based on a two-dimensional image captured by a camera;
calculating a skeleton vector based on the detected two-dimensional skeletal structure, the skeleton vector indicating a direction and a size of a skeleton of the person in the two-dimensional image; and
calculating a camera parameter of the camera based on the calculated skeleton vector.

### (Supplementary Note 18)

The non-transitory computer readable medium according to Supplementary note 17, wherein
the skeleton vector is a vector corresponding to a bone included in the two-dimensional skeletal structure or a vector corresponding to a central axis of the two-dimensional skeletal structure.

### REFERENCE SIGNS LIST

1 CAMERA CALIBRATION SYSTEM
10 CAMERA CALIBRATION APPARATUS
11 SKELETON DETECTION UNIT
12 VECTOR CALCULATION UNIT
13 PARAMETER CALCULATION UNIT
20 COMPUTER
21 PROCESSOR
22 MEMORY
100 CAMERA CALIBRATION APPARATUS
101 IMAGE ACQUISITION UNIT
102 SKELETAL STRUCTURE DETECTION UNIT
103 VECTOR CALCULATION UNIT
104 AGGREGATION UNIT
105 CAMERA PARAMETER CALCULATION UNIT
106 STORAGE UNIT
200 CAMERA
300, 301 HUMAN BODY MODEL
401 TWO-DIMENSIONAL SKELETAL STRUCTURE
402 THREE-DIMENSIONAL HUMAN BODY MODEL

What is claimed is:

1. A camera calibration apparatus comprising:
at least one memory storing instructions, and
at least one processor configured to execute the instructions stored in the at least one memory to;
detect a two-dimensional skeletal structure of a person based on a two-dimensional image captured by a camera;
calculate a skeleton vector based on the detected two-dimensional skeletal structure, the skeleton vector indicating a direction and a size of a skeleton of the person in the two-dimensional image; and
calculate a camera parameter of the camera based on the calculated skeleton vector.

2. The camera calibration apparatus according to claim 1, wherein
the skeleton vector is a vector corresponding to a bone included in the two-dimensional skeletal structure or a vector corresponding to a central axis of the two-dimensional skeletal structure.

3. The camera calibration apparatus according to claim 1, wherein
the skeleton vector is a vector based on a part of the two-dimensional skeletal structure.

4. The height estimation apparatus according to claim 3, wherein
the at least one processor is further configured to execute the instructions stored in the at least one memory to calculate the skeleton vector based on a bone of one of a foot part, a torso part, or a head part included in the two-dimensional skeletal structure.

5. The camera calibration apparatus according to claim 3, wherein
the at least one processor is further configured to execute the instructions stored in the at least one memory to calculate the skeleton vector based on bones from a foot part to a torso part or bones from the torso part to a head part included in the two-dimensional skeletal structure.

6. The camera calibration apparatus according to claim 1, wherein
the skeleton vector is a vector based on the entire two-dimensional skeletal structure.

7. The camera calibration apparatus according to claim 6, wherein
the at least one processor is further configured to execute the instructions stored in the at least one memory to calculate the skeleton vector based on a sum of lengths of bones from a foot part to a head part included in the two-dimensional skeletal structure.

8. The camera calibration apparatus according to claim 6, wherein
the at least one processor is further configured to execute the instructions stored in the at least one memory to calculate the skeleton vector based on a two-dimensional skeleton model indicating a relationship between a length of a bone included in the two-dimensional skeletal structure and a length of a whole body of the person in the two-dimensional image space.

9. The camera calibration apparatus according to claim 6, wherein
the at least one processor is further configured to execute the instructions stored in the at least one memory to calculate the skeleton vector based on a three-dimensional skeleton model fitted to the two-dimensional skeletal structure.

10. The camera calibration apparatus according to claim 1, wherein the at least one processor is further configured to execute the instructions stored in the at least one memory to:
aggregate a plurality of the calculated skeleton vectors; and
calculate the camera parameter based on the aggregated skeleton vectors.

11. The camera calibration apparatus according to claim 10, wherein
the at least one processor is further configured to execute the instructions stored in the at least one memory to aggregate the skeleton vectors for each area obtained by dividing the two-dimensional image.

12. The camera calibration apparatus according to claim 1, wherein
the at least one processor is further configured to execute the instructions stored in the at least one memory to calculate the camera parameter based on the calculated skeleton vector and a reference value of the skeleton of the person.

13. The camera calibration apparatus according to claim 12, wherein
the reference value is a statistical value of the height or the length of the bone of the person.

14. The camera calibration apparatus according to claim 12, wherein
the reference value is a value corresponding to an attribute of the person.

15. A camera calibration method comprising:
detecting a two-dimensional skeletal structure of a person based on a two-dimensional image captured by a camera;
calculating a skeleton vector based on the detected two-dimensional skeletal structure, the skeleton vector indicating a direction and a size of a skeleton of the person in the two-dimensional image; and
calculating a camera parameter of the camera based on the calculated skeleton vector.

16. The camera calibration method according to claim 15, wherein
the skeleton vector is a vector corresponding to a bone included in the two-dimensional skeletal structure or a vector corresponding to a central axis of the two-dimensional skeletal structure.

17. A non-transitory computer readable medium storing a camera calibration program for causing a computer to execute processing of:
detecting a two-dimensional skeletal structure of a person based on a two-dimensional image captured by a camera;
calculating a skeleton vector based on the detected two-dimensional skeletal structure, the skeleton vector indicating a direction and a size of a skeleton of the person in the two-dimensional image; and
calculating a camera parameter of the camera based on the calculated skeleton vector.

18. The non-transitory computer readable medium according to claim 17, wherein
the skeleton vector is a vector corresponding to a bone included in the two-dimensional skeletal structure or a vector corresponding to a central axis of the two-dimensional skeletal structure.
